(19) United States
(12) Patent Application Publication
(10) Pub. No.: US 2026/0135784 A1
(43) Pub. Date: May 14, 2026

(54) SYSTEM AND METHOD FOR VARIABLE SAMPLE RATE SIGNAL ACQUISITION

(71) Applicant: Tektronix, Inc., Beaverton, OR (US)

(72) Inventor: Jonathan D. Clem, Hillsboro, OR (US)

(21) Appl. No.: 19/385,043

(22) Filed: Nov. 10, 2025

Related U.S. Application Data
(60) Provisional application No. 63/719,975, filed on Nov. 13, 2024.

(51) Int. Cl. H04L 43/022

(52) U.S. Cl. CPC H04L 43/022

(57) ABSTRACT

A test and measurement instrument includes an input for accepting an input signal that varies in amplitude over time, the input signal formed of a number of waveform segments, a sampler structured to sample the input signal at regular intervals to produce a sampled signal, the sampled signal formed of a number of sample segments that each correspond to one of the waveform segments, an acquisition processor including a slew rate controller structured to determine an instant rate of change of amplitude in a selected one of the waveform segments of the input signal as an instant slew rate of the input signal, and a sampling filter structured to store the sampled segment corresponding to the selected one of the waveform segments of the input signal in an acquisition memory only during times that the instant slew rate of the selected segment of the input signal exceeds a slew rate threshold. Methods are also described.

### CROSS-REFERENCE TO RELATED APPLICATIONS

This disclosure is a non-provisional of and claims benefit from U.S. Provisional Application No. 63/719,975, titled “SLEW RATE DEPENDANT SAMPLE RATE FOR SIGNAL ACQUISITION,” filed on Nov. 13, 2024, the disclosure of which is incorporated herein by reference in its entirety.

### TECHNICAL FIELD

This disclosure relates to test and measurement instruments, and more particularly to techniques for acquiring signals in a test and measurement instrument, such as an oscilloscope, for example.

### BACKGROUND

Modern test and measurement devices, such as oscilloscopes, receive analog signals for testing from a Device Under Test (DUT). One of the first steps in processing the analog signals is to convert them to digital signals by using one or more analog-to-digital converters (ADCs). Conventional oscilloscopes have a fixed and continuous sample rate per acquisition from the DUT, but this convention forces the user to compromise on setup details. Since the size of acquisition memory in oscilloscopes is fixed and limited, this compromise usually manifests as a tradeoff between a fast enough sampling rate of the input signal to capture detailed high frequency features of the signal versus a slow enough sample rate to capture enough of the input signal to effectively analyze the longer signal activity. Serial standards are a good example—users are often conflicted between sampling at a fast enough rate to enable anomaly detection on each edge (monotonicity, over/undershoot, etc.), and sampling at a slow enough rate to capture, within the limited memory, full serial bus protocol exchanges in a single acquisition.

In many testing scenarios there are periods of maximum importance, such as fast transitioning edges and an overview of the signal showing timing relationships between all captured edges. Other portions of the input signal, such as dead time between edges where the signal is at a static or relatively stable voltage, is of little value to the user, other than its ability to pinpoint the timing relationship between the edges around it (counted off in sample rate “ticks”). But, since the sample rate of an input signal is determined based on the entirety of the signal, i.e., the important parts as well as the less-important parts, much of the sampled signal has little value to the user, effectively wasting the already limited memory space of the instrument.

### BRIEF DESCRIPTION OF THE DRAWINGS

FIG. 1 is a block schematic diagram of a test and measurement instrument including a variable rate acquisition processor according to embodiments of the disclosure.

FIG. 2 illustrates when a fast sample rate may be invoked by the test and measurement instrument of FIG. 1, according to embodiments of the disclosure.

FIG. 3 is a block schematic diagram illustrating example components of the variable rate acquisition rate acquisition processor of FIG. 1, according to embodiments of the disclosure.

FIG. 4A illustrates a data structure scheme that may be used by the variable rate acquisition processor of FIGS. 1 and 3, according to embodiments of the disclosure.

FIG. 4B illustrates another data structure scheme that may be used by the variable rate acquisition processor of FIGS. 1 and 3, according to embodiments of the disclosure.

FIG. 4C illustrates yet another data structure scheme that may be used by the variable rate acquisition processor of FIGS. 1 and 3, according to embodiments of the disclosure.

### DESCRIPTION OF EMBODIMENTS

A solution to selecting a fixed signal acquisition rate, according to embodiments of the disclosure, is found in a variable sample rate instrument that ties the rate at which the digital samples of the analog signal are stored into acquisition memory (the sample rate, SR) to the slew rate (dV/dT) of the signal being measured. When the input signal transitions are at or above a threshold slew rate, the sample rate of the acquisition processor is increased, thereby acquiring the rapidly changing signal with increased fidelity. Conversely, when the slew rate of the input signal is below the threshold slew rate, the acquisition processor reduces the sample rate in compensation, saving acquisition memory space. In this manner, embodiments of the disclosure efficiently store a digitized waveform signal that has increased detail during times of rapid transition, and minimizes the amount of data needed to store the digitized input signal during periods of static or little transition. Although particular embodiments are described with reference to the input signal compared to a single threshold slew rate, embodiments of the invention are not so limited. In other embodiments, the instant or present slew rate of the input signal may be compared to several slew rate thresholds, and the acquisition processor selects one of many different acquisition rates based on the present slew rate of the input signal. Some embodiments include 2, 4, or up to dozens of different slew rates for the system to choose from. Also, although the slew rate is described above as a change in voltage over a unit of time, in embodiments, the numerator could be a change in any measured parameter, and need not necessarily be voltage. Change in current or power, or other measured parameters could also be used. Further, slew rates and slew rate thresholds may be determined as absolute values, or they may include a directional component as well, such as negative or positive slew rates.

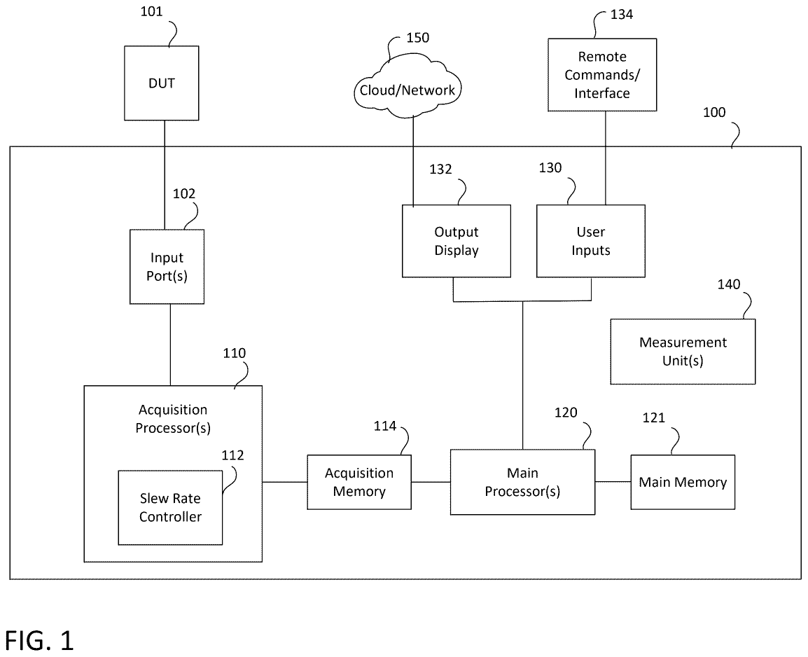

FIG. 1 is an example block diagram of a test and measurement instrument, such as an oscilloscope 100, having a variable rate acquisition processor according to embodiments of the disclosure. In other embodiments the test and measurement instrument may be any instrument or device that creates digital samples from an analog input signal, such as logic analyzers, bit error rate testers, protocol analyzers, and other devices. The oscilloscope 100 of FIG. 1 includes one or more input ports 102, which may be any electrical or optical signaling medium. Ports 102 may include receivers and/or transceivers. Each port 102 is a channel of the oscilloscope 100. In some embodiments the oscilloscope 100 includes 8, 16, or more separate ports. The oscilloscope 100 may couple to a Device Under Test (DUT) 101 through one or more ports 102. DUTs 101 that have multiple outputs may connect each output to the oscilloscope 100 through multiple, independent ports 102.

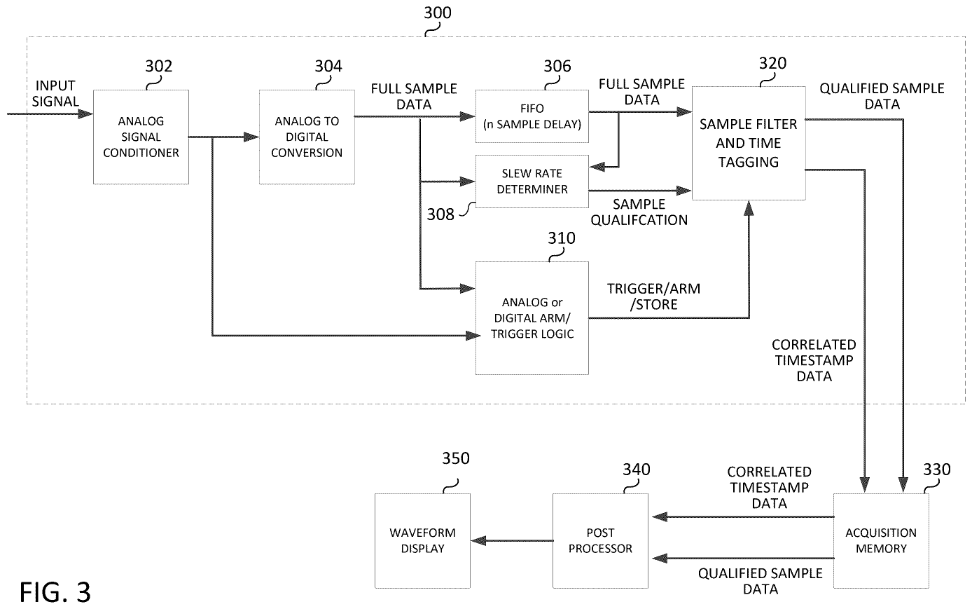

The input signals received at the ports 102 are then sent, in analog form, to an acquisition processor 110, which accepts the input signal, filters or conditions it, and converts the input signal to a digital waveform, which is then stored in an acquisition memory 114. As described above, the rate at which the waveform data is stored in the acquisition memory 114 is dependent on the slew rate of the input signal, i.e, how fast the signal is changing over time. The oscilloscope 100 may include a single acquisition processor 110 that receives all of the inputs from the one or more ports 102, or each input port 102 may include a dedicated signal acquisition processor. In other embodiments there may be fewer acquisition processors 110 than the number of input ports, but still more than a single acquisition processor 110. As described in more detail below, the acquisition processor 110 converts an analog signal received through the one or more ports 102 to digital data that represents the input signal, and stores the signal in the acquisition memory 114. The acquisition rate of the acquisition processor 110 may be controlled by a slew rate controller 112, which controls the acquisition processor to modify its acquisition rate based on qualities of the input signal, such as the rate at which the input signal is changing, i.e., its slew rate. This slew-rate based control of the acquisition processor 110 is described in detail with reference to FIG. 3 below.

The acquisition memory 114 may be a relatively large, but finite, memory that is structured to quickly store large amounts of incoming data. The acquisition memory 114 may be implemented as volatile memory or as solid-state memory, such as a solid-state disk drive(s) depending on implementation details.

The oscilloscope 100 also includes one or more main processor(s) 120 configured to execute instructions from main memory 121 and may perform any methods and/or associated steps indicated by such instructions. The one or more main processor(s) 120 control the operation of the oscilloscope 100 based on these instructions. The one or more main processor(s) 120 may be formed of traditional microprocessors or a programmable fabric, like a Field Programmable Gate Array (FPGA), or a combination of both types. In some embodiments Digital Signal Processors (DSPs) may also be used in conjunction with the processor(s) 120. In some embodiments the main memory 121 and acquisition memory 114 are combined into a single memory that serves all of the memory purposes described above.

User inputs 130 are coupled to the one or more processor(s) 120, and may include a keyboard, mouse, touchscreen, and/or any other controls employable by a user to interact with a GUI on an output display 132. In some embodiments the user inputs 130 may be connected to or controlled by a remote interface 134, so that a user may control operation of the oscilloscope 100 in a remote location physically away from the instrument. The user inputs 130 may also accept program instruction commands. The display 132 may be a digital screen such as a Liquid Crystal Display, Light Emitting Display, or any other type of monitor to display waveforms, measurements, and other data to a user. In some embodiments, the output display 132 may include a local display on the oscilloscope 100, and also include a display located remote from the oscilloscope. In some embodiments, the user inputs 130 include a menu through which a user of the oscilloscope 100 may set up or control the acquisition processor 110 and slew rate controller 112 using any of the techniques described above.

One or more measurement units 140 are illustrated as being part of the oscilloscope 100. These measurement units 140 perform the main functions of measuring parameters and other qualities of signals from the DUT 101 being measured by the oscilloscope 100 and analyzed by the user. Typical measurements include measuring voltage, current, and power of input signals in the time domain, as well as measuring features of the input signals in the frequency domain. The measurement units 140 represent any measurements that are typically performed on test and measurement instruments.

While the components of the oscilloscope 100 are depicted as being integrated within oscilloscope 100, it will be appreciated by a person of ordinary skill in the art that any of these components can be external to the oscilloscope 100 and can be coupled to the oscilloscope 100 in any conventional manner (e.g., wired and/or wireless communication media and/or mechanisms). For example, in some examples, data or images generated by the oscilloscope 100 may be made available to other devices through a cloud or other type of communication network 150.

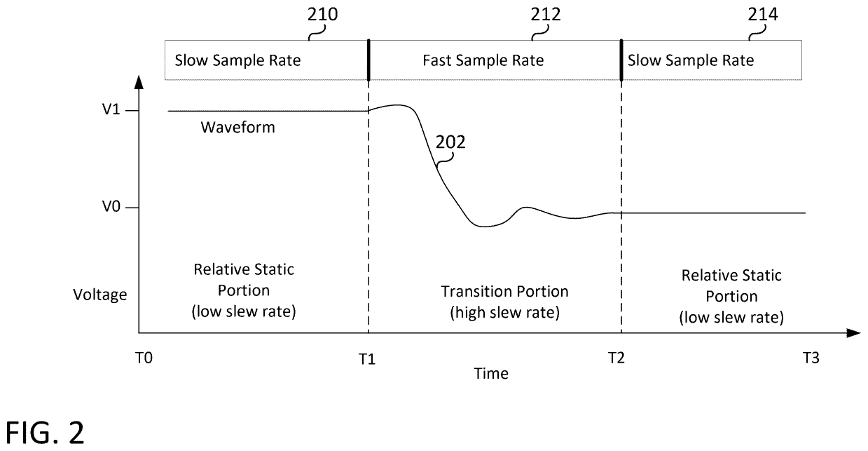

Determining a slew rate of an input signal can be performed in a number of ways. In one method, this determination could be implemented as any formula SR=f(dV/dT), where dV/dT means a change in voltage over a change in time. A directly proportional SR=k(dV/dT) where k is a constant, is the simplest conceptually, but rather complex in practical application. A more practical implementation is to have discrete steps, meaning the acquisition processor 110 is programmed or controlled to select any one of n possible sample rates. In the simplest embodiment, described below, n=1, meaning that the full sample rate of the oscilloscope is used for periods of rapid input signal transition, while no samples are gathered during static portions of the input signal, as described with reference to FIGS. 2 and 3.

FIG. 2 illustrates a portion of an example waveform 202 that is relatively static at a first voltage V1 between times T0-T1, and is relatively static at a second voltage V0 between times T2 and T3. A transition portion of the waveform 202 occurs between times T1 and T2, when the waveform is changing from V1 to V0. The illustrated portion of the waveform 202 is referred to as a falling edge, and is typical for signals carried on serial busses of a DUT. Although not illustrated, in the time following T3, the waveform 202 may subsequently have a rising edge, where the waveform transitions back from V0 to V1.

As described above, the information to be learned about the waveform 202 mostly centers around the transition period between times T1 and T2. Other portions of the waveform 202 are of little use to the user analyzing the waveform, as the waveform is relatively static during these other time periods. Embodiments of the disclosure control the sample rate for the acquired waveform, such as waveform 202 as shown in the upper portion of FIG. 2. A slow sample rate 210 is applied during times T0 and T1, and a slow sample rate 214 is applied between times T2 and T3. Conversely, a fast sample rate is applied during times T1 and T2, when the waveform 202 is transitioning between the voltages V1 and V2. In some embodiments, the fast sample rate 212 is the full, or highest rate that the oscilloscope 100 (FIG. 1) is capable of, in order to store the greatest detail of the transition period. The slow sample rates 210, 214 may be any rate lower than the fast or fastest sample rate 212. As mentioned above, the slow sample rate may be one of a number of discrete rates that are slower than the fast sample rate. In a particular embodiment, described below, the slow sample rates 210, 214 may be a 0 sample rate, i.e., the waveform 202 is not sampled at all during the relative static portions T0 and T1 as well as T2 and T3. In this particular embodiment, additional data is stored along with the sampled data to indicate that the waveform 202 is not transitioning during the periods during which data is not stored. This case is described in detail below. Portions of the waveform 202 having different sample rates may be referred to as different segments of the waveform. For example, with reference to FIG. 2, a first segment of the waveform includes the waveform from time T0 to T1. A second segment of the waveform includes the waveform from time T1 to T2, and a third segment of the waveform includes the waveform from time T2 to T3. The waveform may include any number of segments from 1 to several billion segments.

While the example of FIG. 2 is illustrated as a waveform 202 having a changing voltage, changes in other measured parameters, such as current, power, or any other measured parameter, may be used to control the rate at which data is stored in the acquisition memory by determining how fast the measured parameter is changing, and selecting the rate at which the data is stored based on such information.

FIG. 3 is a block schematic diagram illustrating example components of a variable rate acquisition rate acquisition processor 300, according to embodiments of the disclosure. The acquisition processor 300 may be an example of the acquisition processor 110 of FIG. 1, although other methods of implementing the acquisition processor 110 are also possible. In other words, embodiments of the disclosure are not limited to the specific components or detail of the acquisition processor 300 illustrated in FIG. 3.

The acquisition processor 300 receives an input signal, which is conditioned by an analog signal conditioner 302. Such conditioning may include low-pass or band-pass filtering, or other filtering as selected by the user. After the input signal is filtered, an ADC 304 converts the filtered input signal to a digital sample. The ADC 304 has a sampling rate that is sufficient to sample the input signals with enough resolution to be usable by the oscilloscope 100 (FIG. 1), and may be 8-bit, 12-bit, or higher bit resolution ADC. The digitally sampled signal output from the ADC 304 is referred to as the full sample data.

The full sample data is temporarily stored in a data buffer, referred to in FIG. 3 as First In First Out (FIFO) 306. The FIFO 306 is a fixed-size buffer, and acts as a delay to the full sample data. Once the FIFO 306 is full, each time another piece of data is pushed into the FIFO, another piece of data is presented at an output. The time delay of the FIFO 306 is directly related to the size of the FIFO, and how quickly the data is being sampled. In one example, the data is sampled by the ADC 304 at 2.5 Giga Samples per Second (GS/s), and the FIFO 306 stores 32 samples. Thus, the data stored in the FIFO 306 spans a time period of 12.8 ns. In this example, each of the 32 samples in the FIFO 306 represents 400 ps of data. Of course the size of the FIFO 306 and rate at which data is sampled by the ADC 304 is implementation specific, and not limited to these examples.

A slew rate determiner 308 receives inputs from both the input and output of the FIFO 306. Since the size of the FIFO 306 is predetermined, and represents a finite period of time for a given sample rate, any change in the magnitude of the input signal between the first and last samples of the FIFO 306 corresponds to a change in signal amplitude over a known period of time. The slew rate determiner 308 measures the coded difference (output from the ADC 304) between the first and last samples in the FIFO 306. Since the time period of the input signal stored in the FIFO 306 is known, determining this difference in ADC codes is used to determine the slew rate of the digitized input signal. Other threshold slew rates are also possible depending on the needs of the user, as described above.

Referring back to the SR=f(dV/dT) equation, the ADC code difference determined by the slew rate determiner 308 represents the “dV”, and the number of samples in the FIFO 306 represents the “dT”. For example, if the dT of the FIFO 306 stores 32 samples at 400 ps (12.8 ns) and the dV is 1V, this roughly translates to 32 ADC codes at a vertical resolution setting of 800 mV/div. In one embodiment, when the input signal is transitioning above this 1V/12.8 ns dV/dT threshold, the example system stores all samples at the maximum rate, and, when the input signal is transitioning below this threshold, no samples are stored.

Output from the slew rate determiner 308 is passed to a sample filter and time tagging component 320, which also receives input from arming and/or triggering logic 310, which determines what portions of the input signal are to be stored in an acquisition memory 330, and at what rate. In operation, the arming and/or triggering logic 310 determines which portion of the input signal are to be stored by the oscilloscope. For example, if the user wishes only to evaluate HIGH to LOW transitions of the input signal, then the triggering logic 310 is programmed to ignore LOW to HIGH transitions of the input signal, no matter whether the slew rate of such transitions is above the slew threshold.

The sample filter and time tagging component 320, which also may be referred to as a downsampler, receives the full sample data from the ADC 304, instant slew rate information about the input signal from the slew rate determiner 308, as well as the arming and/or triggering logic 310, and determines whether the digital samples from the input waveform are stored or skipped. The sample filter and time tagging component 320 may additionally store the one or more slew rate thresholds. In embodiments having multiple sample rates, the sample filter and time tagging component 320 can determine which portions of the full sample data will be stored at the full rate and any reduced rate by comparing the instant slew rate to the set of slew rate thresholds and selecting the predetermined data storage rate that corresponds to the comparison. In other words, the sample filter and time tagging component 320 may filter the full rate data to produce a reduced rate sample. And, what reduced rate to apply to the full sample data is controlled by the output of the slew rate determiner 308, which compares the slew rate of the input signal to the one or more threshold slew rates. It should be noted that, in embodiments, the reduced rate does not change the bit depth or the sample rate of the ADC 304, but instead decimates, down samples, or otherwise converts the full sample data to the selected data storage rate. Waveform data stored at a reduced data storage rate occupies less space than does the full sample rate.

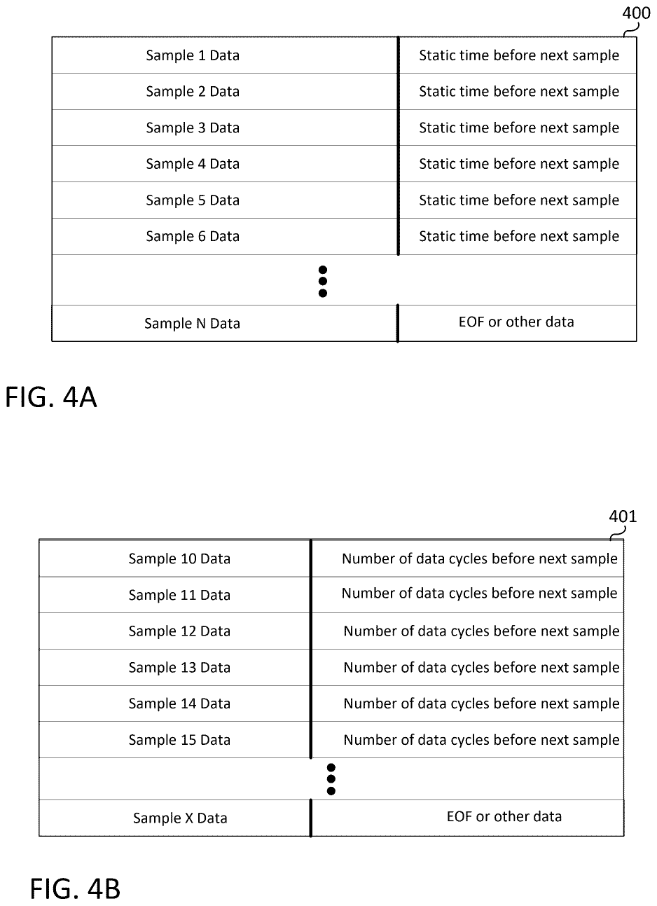

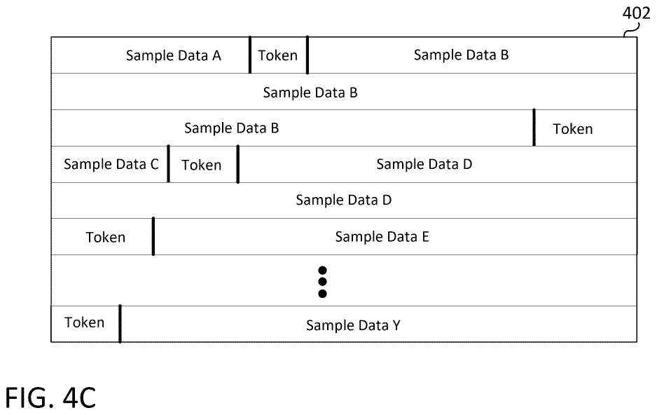

In the particular embodiment described above, when no samples of the digitized input waveform are stored during time periods of little or no slew rate, the samples are tagged to indicate how long, or how many samples, were skipped and not stored. This is described in more detail with reference to FIGS. 4A and 4B below.

To re-create the sampled waveform on a waveform display 350, which may be an embodiment of the output display 132 of FIG. 1, the oscilloscope retrieves the sample data that was previously stored in the acquisition memory 330, using the techniques described above. Next, a post processor 340 uses the sample data stored in the acquisition memory 330 as well as the timestamp or zero-time data (described below in more detail) to form the re-created, full waveform signal representation.

Referring back to FIGS. 2 and 3, the waveform 202 exhibits a low slew rate between times T0-T1 and T2-T3. During these time periods, the slew rate determiner 308 controls the sample filter and time tagging component 320 to store samples in the acquisition memory 330 at a lower sample rate, which may be a zero rate. And, between times T1 and T2, when the waveform 202 exhibits a high slew rate, the slew rate determiner 308 controls the sample filter and time tagging component 320 to store samples in the acquisition memory 330 at the full sample rate of the oscilloscope.

Embodiments, due to the presence of the FIFO 306, also allow some signal history to be captured and stored. For example, a certain amount of samples preceding the transition period may be stored along with the data stored at the fully sampled rate. In one example, 6.4 ns of samples prior to the time T1, i.e., the falling edge are stored in the acquisition memory. This allows the user to view actual stored data from the waveform 202 rather than data that is re-created by the post processor 340 had such data not been stored. Similarly, waveform data after the slew rate of the waveform 202 falls below the present slew threshold may also be stored, ensuring that the user sees the complete transition portion of the waveform 202. In one embodiment the oscilloscope 100 stores 25.6 ns after the last qualifying dV/dT sample. This helps ensure small ringing details are captured even if they don't themselves meet the dV/dT criteria. Of course, these parameters, such as the threshold slew rates and the amount of data stored before and after transition periods, may be controlled by the user, and may be selected to most benefit the user.

In systems that store no data during the relatively static portions of the waveform transition, a separate mechanism is needed to recover the missing timing information during post processing of the stored acquisition data by the post processor 340. To accomplish this, the oscilloscope 100 uses a timing marker that gets stored into acquisition memory 330 to indicate how many samples were not stored. The timing marker is inserted into the acquisition memory by the sample filter and time tagging component 320. Post processing of the acquisition data, such as by the post processor 340, can then reconstruct the exact timing of the original waveform, even though portions of the original waveform were not stored as samples, by inserting the corresponding amount of dead time in the recovered waveform. In other words, instead of storing waveform samples during times when the waveform is experiencing low slew rates, information about how long the waveform was not sampled is stored instead. Storing this information uses significantly less memory than storing waveform sample data, even if very low sample rates are chosen. FIGS. 4A and 4B illustrate two sample implementations, although other implementations can be used with embodiments.

FIG. 4A illustrates contents of the acquisition memory 400, which may be an example of the acquisition memory 330 (FIG. 3) that uses time information that the post processor 340 uses to re-create the waveform to present on the waveform display 350. In this example, after the sample data (Sample Data 1) is stored, an indication of how long the signal stays at it last output level prior to the next sample (Sample Data 2) is also stored. Recall that, during the relatively static portions of the acquired waveform, the waveform stays at its same (or very near) its last output level. Thus, the post processor 340 uses the static time information stored along with the sample data to determine how long to keep the present sample (Sample 1) at its last output level before recreating the next sampled data (Sample 2). This system repeats until the entire waveform is recreated by the post processor 340. Since the data representing this static time data is very compact, very little memory space in the acquisition memory is used to store the information, while still allowing the post processor 340 to faithfully recreate the entirety of the originally sampled waveform. The final piece of data in the acquisition memory 400 may be used to indicate to the post processor 340 that it is the last sample, or may include other information used by the post processor 340 to recreate the sample. FIG. 4B shows a similar concept in an acquisition memory 401. In this example, however, instead of time data, the acquisition memory 401 stores a count of how many cycles the waveform stays at its same level before moving on to a subsequent sample for recreation.

Embodiments of the disclosure thus allow the most important parts of the waveform to be sampled and stored, while the less important parts of the waveform, which are relatively easy to recreate because they are static, may be represented in very compact form. In one example, if a waveform spanning 55 mS of real time was sampled at the full 2.5 Giga Samples/Sec. rate, a conventional oscilloscope would require more than 100 Mega Samples to store the entire sample, which includes all timing relationships between edges stored to 400 ps resolution. Embodiments according to the disclosure, however, by effectively eliminating the need to store unimportant portions of the waveform, can recreate the entire waveform and only use less than 1 Mega Samples.

Some oscilloscopes in the past have attempted to store less data than full-rate samples by dividing up acquisition memory and storing some number of shorter acquisitions in that space. Such solutions do not store inter-frame timing information though, so, unlike embodiments according to the disclosure, they cannot faithfully reproduce the complete original waveform.

In some cases, signals that are not completely static and have a slow dV/dT that is under the threshold to trigger storage using the present embodiments, can be problematic. These signals have the potential to drift over large voltages over a long time span, yet those changes may fail to be recorded in acquisition memory according to the embodiments described above. To address this, some embodiments may include a minimum sample rate for all cases. Including a minimum sample rate discrete step address the drift issue at a cost of using more acquisition memory, but still uses less memory than storing all waveform samples at the maximum rate.

An alternative to using a minimum sample rate for slow changing signals is described in U.S. Pat. No. 10,670,632, which is incorporated by reference herein. This '632 patent describes a system and method to capture slow changing signal activity while still allowing for absolutely no samples stored for true DC input. The method in the '632 patent, however, is inadequate to capture the fine timing details of fast moving edges, since it requires timestamping of every sample. Thus, some implementations of embodiments may combine the system and methods described above in conjunction with the methods described in the '632 patent to provide a robust overall solution. In such a combined system, edges of the input waveform that are above the threshold slew rate, described above, are stored at the full sample rate. Then, slower changing signals are stored in the acquisition memory using the methods described in the '632 patent, which describes intermittent storing of samples exhibiting slower slew rates.

FIG. 4C illustrates contents of the acquisition memory 402, which may be an example of the acquisition memory 330 (FIG. 3) that uses tokens to store information used by the post processor 340 to re-create the waveform to present on the waveform display 350. Each unit grouping stored in the memory includes an identifier that identifies the contents of the grouping as storing a data token or a storing data sample. In one embodiment, data tokens store elapsed time from the previous data sample as well as the sample rate of the subsequent sample. Data tokens can be defined as multiple bytes and understood as such by the post processor 340 so that there is enough information so that the post processor 340 can reconstruct the sampled signal from the information stored in the memory 402. Since data tokens may be short compared to the actual sampled data, most of the acquisition memory 402 is filled with actual data samples rather than timestamps as in previous solutions. In some embodiment, data tokens are only stored when there is a sample rate change or in the rare event when an extended dead time exceeds the maximum data value that can be stored in a single data token. Such a token-based memory structure as described above supports using a full sample rate for embodiments where memory bandwidth is a limiting factor of sustained sample rate.

Although several examples of data tokens or other data stored in the acquisition memory in association with the stored samples, the type and contents of such accompanying data is implementation specific, and embodiments are not limited to any particular type of data, so long that it adequately communicates sufficient information to the post processor 340 to reconstruct a representation of the input signal acquired by the test and measurement instrument, such as an oscilloscope. Such information may include, in addition to the stored samples themselves, slew-rate information, sample rate information, and time or cycle information describing an amount of time portions of the sampled input signal is not being sampled and stored into the acquisition memory.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement instrument including an input for accepting an input signal that varies in amplitude over time, the input signal formed of a number of waveform segments, a sampler structured to sample the input signal at regular intervals to produce a sampled signal, the sampled signal formed of a number of sample segments that each correspond to one of the waveform segments, an acquisition processor including a slew rate controller structured to determine an instant rate of change of amplitude in a selected one of the waveform segments of the input signal as an instant slew rate of the input signal, and a sampling filter structured to store the sampled segment corresponding to the selected one of the waveform segments of the input signal in an acquisition memory only during times that the instant slew rate of the selected segment of the input signal exceeds a slew rate threshold.

Example 2 is a test and measurement instrument according to Example 1, in which the sampling filter is further structured to not store the sampled segment in the acquisition memory during times when the instant slew rate of the input signal does not exceed the slew rate threshold.

Example 3 is a test and measurement instrument according to any preceding Example, in which the sampling filter stores an indicator in the acquisition memory to denote that the instant slew rate of the input signal does not exceed the slew rate threshold.

Example 4 is a test and measurement instrument according to any preceding Example, in which the indicator includes one or more of a group consisting of: a time value, a number of cycles value, and a slew rate value.

Example 5 is a test and measurement instrument according to any of preceding Example in which the sampling filter stores an indicator for each sampled segment stored in the acquisition memory.

Example 6 is a test and measurement instrument according to any preceding Example, further comprising a post processor structured to create an output waveform from one or more sampled segments retrieved from the acquisition memory and an indicator or any other retrieved information that was stored in the acquisition memory in association with the one or more sampled segments.

Example 7 is a test and measurement instrument according to Example 2 in which the sampling filter comprises a downsampler, and in which the sampling filter stores a downsampled version of the sampled segment in the acquisition memory during times when the instant slew rate of the input signal does not exceed the slew rate threshold.

Example 8 is a test and measurement instrument according to any preceding Example, in which the slew rate detector is structured to compare an input amplitude value of a fixed-length data buffer to an output amplitude value of the fixed-length data buffer.

Example 9 is a test and measurement instrument according to any preceding Example, further comprising a trigger processor having an output coupled to the sampling filter, and in which the sampling filter uses the output of the trigger processor as a control signal.

Example 10 is a method in test and measurement instrument comprising accepting a waveform having one or more waveform segments, sampling the waveform to produce a sampled signal, the sampled signal formed of a number of sample segments that each correspond to one of the one or more waveform segments, determining a slew rate of a present waveform segment, and storing the sampled segment corresponding to the present waveform segment in an acquisition memory only when the slew rate of the present waveform segment exceeds a slew rate threshold.

Example 11 is a method according to Example 10, further comprising refraining from storing the sampled segment corresponding to the present waveform segment when the slew rate of the present waveform segment does not exceed the slew rate threshold.

Example 12 is a method according to any preceding Example method, further comprising storing an indicator in the acquisition memory that denotes an amount of time or a number of cycles that the slew rate of the present waveform segment does not exceed the slew rate threshold.

Example 13 is a method according to any preceding Example method, further comprising storing slew rate information in the acquisition memory identifying the slew rate of the present waveform segment.

Example 14 is a method according to any preceding Example method, further comprising storing sample rate information in the acquisition memory identifying a sample rate at which the present waveform segment is stored in the acquisition memory.

Example 15 is a method according to any preceding Example method, in which determining a slew rate of a current waveform segment comprises comparing a first amplitude value stored in a fixed-size data buffer to a second amplitude value stored in the fixed-sized data buffer.

Example 16 is a method according to Example 15, in which the first amplitude value is a value that has been stored in the fixed-size data buffer a longest amount of time, and in which the second amplitude value is a next amplitude value to be stored in the fixed-sized data buffer.

Example 17 is a method according to Example 16, in which the first amplitude value is a value that has been stored in the fixed-size data buffer a longest amount of time, and in which the second amplitude value is the latest value to be stored in the fixed-sized data buffer.

Example 18 is a test and measurement instrument including an input for accepting an input signal that varies in amplitude over time, the input signal formed of one or more waveform segments, and one or more processors configured to execute operations to cause the one or more processors to sample the input signal to produce a sampled signal, the sampled signal formed of a number of sample segments that each correspond to one of the one or more waveform segments, determine a slew rate of a current waveform segment, and store the sampled segment corresponding to the current waveform segment in an acquisition memory only when the slew rate of the current waveform segment exceeds a slew rate threshold.

Example 19 is a test and measurement instrument according to Example 18, in which the one or more processors are configured to execute operations to cause the one or more processors to refrain from storing the sampled segment corresponding to the current waveform segment when the slew rate of the current waveform segment does not exceed the slew rate threshold.

Example 20 is a test and measurement instrument according to Example 18 or Example 19, in which the one or more processors are configured to determine the slew rate of a current waveform segment by being configured to compare a first amplitude value stored in a fixed-size data buffer to a second amplitude value stored in the fixed-sized data buffer.

Example 21 is a test and measurement instrument according to Example 20, in which the first amplitude value and the second amplitude value is a value of voltage, current, or power.

Example 22 is a test and measurement instrument according to any of Examples 18-21, in which the one or more processors are configured to execute operations to cause the one or more processors to store an indicator in the acquisition memory that denotes an amount of time or a number of cycles that the slew rate of the current waveform segment does not exceed the slew rate threshold.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

What is claimed is:

1. A test and measurement instrument, comprising:
an input for accepting an input signal that varies in amplitude over time, the input signal formed of a number of waveform segments;
a sampler structured to sample the input signal at regular intervals to produce a sampled signal, the sampled signal formed of a number of sample segments that each correspond to one of the waveform segments;
an acquisition processor including a slew rate controller structured to determine an instant rate of change of amplitude in a selected one of the waveform segments of the input signal as an instant slew rate of the input signal; and
a sampling filter structured to store the sampled segment corresponding to the selected one of the waveform segments of the input signal in an acquisition memory only during times that the instant slew rate of the selected segment of the input signal exceeds a slew rate threshold.

2. The test and measurement instrument according to claim 1, in which the sampling filter is further structured to not store the sampled segment in the acquisition memory during times when the instant slew rate of the input signal does not exceed the slew rate threshold.

3. The test and measurement instrument according to claim 2, in which the sampling filter stores an indicator in the acquisition memory to denote that the instant slew rate of the input signal does not exceed the slew rate threshold.

4. The test and measurement instrument according to claim 3, in which the indicator includes one or more of a group consisting of: a time value, a number of cycles value, and a slew rate value.

5. The test and measurement instrument according to claim 4, in which the sampling filter stores an indicator for each sampled segment stored in the acquisition memory.

6. The test and measurement instrument according to claim 4, further comprising:
a post processor structured to create an output waveform from one or more sampled segments retrieved from the acquisition memory and an indicator or any other retrieved information that was stored in the acquisition memory in association with the one or more sampled segments.

7. The test and measurement instrument according to claim 2 in which the sampling filter comprises a downsampler, and in which the sampling filter stores a downsampled version of the sampled segment in the acquisition memory during times when the instant slew rate of the input signal does not exceed the slew rate threshold.

8. The test and measurement instrument according to claim 1, in which the slew rate detector is structured to compare an input amplitude value of a fixed-length data buffer to an output amplitude value of the fixed-length data buffer.

9. The test and measurement instrument according to claim 1, further comprising a trigger processor having an output coupled to the sampling filter, and in which the sampling filter uses the output of the trigger processor as a control signal.

10. A method in test and measurement instrument, the method comprising:
accepting a waveform having one or more waveform segments;
sampling the waveform to produce a sampled signal, the sampled signal formed of a number of sample segments that each correspond to one of the one or more waveform segments;
determining a slew rate of a present waveform segment; and
storing the sampled segment corresponding to the present waveform segment in an acquisition memory only when the slew rate of the present waveform segment exceeds a slew rate threshold.

11. The method according to claim 10, further comprising refraining from storing the sampled segment corresponding to the present waveform segment when the slew rate of the present waveform segment does not exceed the slew rate threshold.

12. The method according to claim 11, further comprising storing an indicator in the acquisition memory that denotes an amount of time or a number of cycles that the slew rate of the present waveform segment does not exceed the slew rate threshold.

13. The method according to claim 10, further comprising storing slew rate information in the acquisition memory identifying the slew rate of the present waveform segment.

14. The method according to claim 10, further comprising storing sample rate information in the acquisition memory identifying a sample rate at which the present waveform segment is stored in the acquisition memory.

15. The method according to claim 10, in which determining a slew rate of a current waveform segment comprises comparing a first amplitude value stored in a fixed-size data buffer to a second amplitude value stored in the fixed-sized data buffer.

16. The method according to claim 15, in which the first amplitude value is a value that has been stored in the fixed-size data buffer a longest amount of time, and in which the second amplitude value is a next amplitude value to be stored in the fixed-sized data buffer.

17. The method according to claim 15, in which the first amplitude value is a value that has been stored in the fixed-size data buffer a longest amount of time, and in which the second amplitude value is the latest value to be stored in the fixed-sized data buffer.

18. A test and measurement instrument, comprising:
an input for accepting an input signal that varies in amplitude over time, the input signal formed of one or more waveform segments; and
one or more processors configured to execute operations to cause the one or more processors to:
sample the input signal to produce a sampled signal, the sampled signal formed of a number of sample segments that each correspond to one of the one or more waveform segments;
determine a slew rate of a current waveform segment; and
store the sampled segment corresponding to the current waveform segment in an acquisition memory only when the slew rate of the current waveform segment exceeds a slew rate threshold.

19. The test and measurement instrument according to claim 18, in which the one or more processors are configured to execute operations to cause the one or more processors to refrain from storing the sampled segment corresponding to the current waveform segment when the slew rate of the current waveform segment does not exceed the slew rate threshold.

20. The test and measurement instrument according to claim 18, in which the one or more processors are configured to determine the slew rate of a current waveform segment by being configured to compare a first amplitude value stored in a fixed-size data buffer to a second amplitude value stored in the fixed-sized data buffer.

21. The test and measurement instrument according to claim 20, in which the first amplitude value and the second amplitude value is a value of voltage, current, or power.

22. The test and measurement instrument according to claim 18, in which the one or more processors are configured to execute operations to cause the one or more processors to store an indicator in the acquisition memory that denotes an amount of time or a number of cycles that the slew rate of the current waveform segment does not exceed the slew rate threshold.
